(19) United States
(12) Patent Application Publication
(10) Pub. No.: US 2006/0106673 A1
(43) Pub. Date: May 18, 2006

(54) Method of collecting, qualifying and distributing customer leads resulting in increased rate of return on marketing investment

(76) Inventor: Richard Resare, Los Alamitos, CA (US)

Correspondence Address: Mark H. Plager, 9807 Fonte Road, Cypress, CA, 90630-3541, US

(21) Appl. No.: 10/990,873

(22) Filed: Nov. 17, 2004

(51) Int. Cl. G06Q 30/00

(52) U.S. Cl. 705/14

(57) ABSTRACT

The present invention relates to a turnkey system that gathers, qualifies and distributes customer lead information to manufacturer dealers and retailers resulting in an increased rate of return on investment for a marketing campaign. The method comprises at least three steps for collecting, qualifying, and delivering customer leads to retailers and dealers for contact in accordance with purchase horizons. Step 1 is the collection of potential leads and entry into a data base. Step 2 is computer sorting the lead database into qualified and non-qualified leads based upon specifically enumerated factors. Step 3 is the timely delivery of the sorted leads to geographically compatible retailers/dealers for solicitation in accordance with purchase horizon information gathered.

### NOTICE OF COPYRIGHTED MATERIAL IN DISCLOSURE

A portion of the disclosure of this patent document contains material that is subject to copyright protection. The copyright owner has no objection to the facsimile reproduction by anyone of the patent document or the patent disclosure, as it appears in the United States Patent and Trademark Office patent files and records, but otherwise reserves all copyrights whatsoever.

### BACKGROUND OF THE INVENTION

The invention relates in general to a method of identifying customer leads from marketing campaigns such as advertising, promotions and trade shows and increasing the rate of return on the investment from participating in such marketing campaigns. Today, customer lead generation is generally a collection of customer names and addresses collected at trade shows through either solicitation or sweepstakes drawings. The collected names and addresses are then distributed to particular merchants and retailers in geographic areas coordinated with the lead's address. In general, there is no sorting or prioritizing of the leads based upon the lead's purchase interest or purchase horizon. Rather it is a mass collection of names whose purchase interests span the spectrum of disinterested to ready to buy immediately. Consequently, wading through this vast collection of names is time consuming and generally results in the loss of customers who were ready to purchase at the time of collecting their personal lead information based upon the delay in subsequent contact with the lead. This loss of customer leads also results in wasted time, effort and money by the advertisers, as well as decreases the advertiser's rate of return on investment in the advertising campaign or trade show participation.

### SUMMARY OF THE INVENTION

The present invention relates to a turnkey system that gathers, qualifies and distributes customer lead information to manufacturer dealers and retailers, resulting in an increased rate of return on the investment in the marketing campaign. The invention disclosed herein comprises a three-phase business method for collecting, qualifying, and distributing customer leads from marketing event participants which results in an increased rate of return for the expenditures associated with the marketing event over pre-existing lead collection methods.

The initial phase comprises the collection of potential leads through incentive programs at marketing events, i.e., hourly drawings for prizes, or through advertising campaigns, i.e., mail-in coupons for prizes or rebates. The middle phase comprises the culling of lead candidates into qualified and non-qualified lead categories. The final phase is the timely delivery of the culled leads to the local retailers/dealers for immediate solicitation of lead candidates in accordance with their selected purchase horizon which generally results in higher purchase rates from the solicited leads. The increase rate of return is simply calculated by comparing the actual purchaser list to lead list generated from the marketing campaign.

The principles of the present method are applicable to a wide variety of marketing campaigns for consumer products and services. For example, the present method may be used to generate consumer leads through print advertisements, direct mail advertisements, radio, television and internet advertising promotions, trade shows or other live marketing events, and thereafter determine the rate of return on the advertising and promotional investment. The method disclosed herein is preferably used at live events such as trade shows.

Through extensive research, implementation of this method at trade shows generally increases advertiser's and manufacturer's rate of return on advertising investment ten fold. Results will, of course, vary depending on the product, incentive program, event type, and the economy at the time of implementation.

One object of the present invention is to provide a simple turnkey lead collection and management system.

A second object of the invention is to provide increased rate of return on investment in advertising campaign or advertising event participation.

A third object of the invention is to attract potential or prospective customers to join the potential lead pool.

A fourth object of the invention is to generate qualified leads from the lead pool resulting in greater return on advertising investment.

A fifth object of the invention is to provide immediate complete prospect information regarding qualified leads culled from the candidate pool to dealers and retailers.

A sixth object of the invention is to provide a return on investment that will self-liquidate the cost of implementing the invention.

A seventh object of the invention is to increase product sales and profits.

To achieve these and other advantages and in accordance with the purpose of the invention, as embodied and broadly described herein, the invention generally comprises a three phase business method for collecting, qualifying, and distributing customer leads collected from participants in marketing campaigns.

With respect to trade shows and other live marketing events, the first step of this process comprises selection of appropriate lead generators, i.e., personnel for trade show, to collect potential leads. The selection process for personnel to staff the event requires that the persons are friendly, professional, capable of being trained about the product or service and being able to answer questions about the product without sounding like sales pitch or pressure the potential lead. The second step comprises education of dealers/retailers regarding anticipated lead generation prior to distribution. The education of the dealers/retailers comprises how to access the leads once made available, understanding purchase horizons, and using purchase horizons for purposes of timing sales calls to the lead.

When implementing this method with respect to print advertisements, direct mail solicitations, radio, television or internet advertisements, the user skips to directly to this third step of collecting of potential leads through incentive programs, i.e., hourly drawings for prizes at trade shows or live events, or mail-in rebates or sweepstakes prizes for advertising campaigns using print, television or radio media.

The fourth step is culling the lead candidates into qualified and non-qualified lead categories, i.e., those who completed the entries forms properly and those who did not, and then further separating the leads again by purchase horizon.

Step Five is the timely delivery of the culled leads to the local retailers/dealers for immediate solicitation of lead candidates in accordance with their purchase horizons.

### BRIEF DESCRIPTION OF THE DRAWINGS

FIG. 1 is a flow chart of the process steps in an exemplary embodiment of the present invention.

FIG. 2 depicts the preferred embodiment of the entry form used to generate the leads.

### DESCRIPTION OF THE PREFERRED EMBODIMENTS

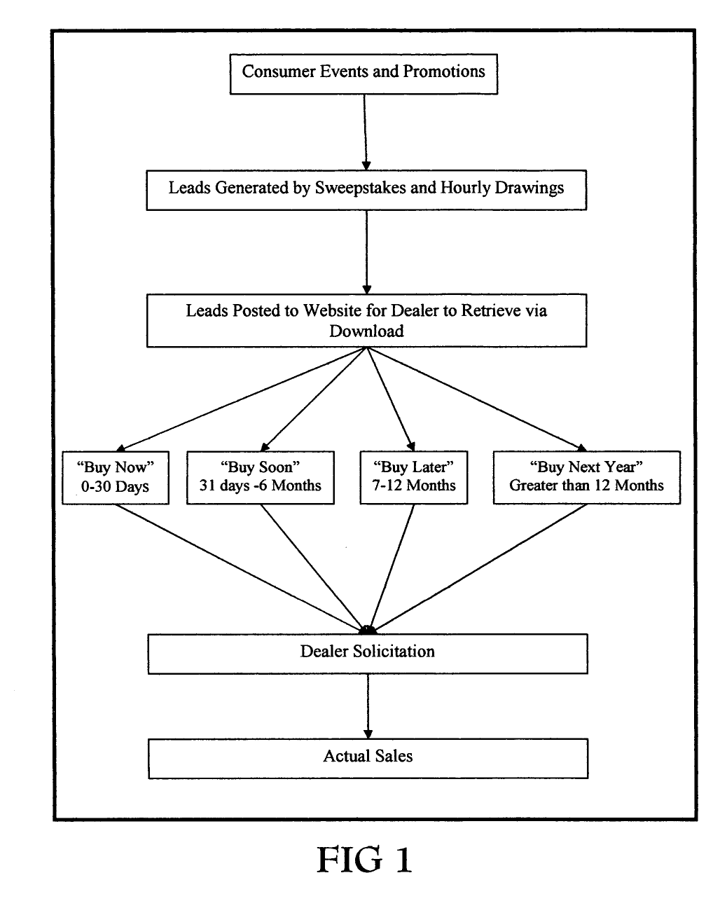

FIG. 1 is a flow chart of the process steps in an exemplary embodiment of the present invention.

For implementation in the environment of a trade show or other live marketing event, the first step is the employment of suitable product specialists to promote the product and interact with potential customers by answering questions and drawing attention and interest in the product, thus supporting the lead generation system. The selection process for personnel to staff the live event requires that the persons are friendly, outgoing, articulate, superior interpersonal skills professional, capable of being trained about the product or service, and thereafter be able to answer questions about the product without sounding like sales pitch or pressuring the potential lead thus generally resulting in the lead being dissuaded from the product or entering the lead pool. No specific formal educational requirements for show personnel, however, preferred experience in sales, guest services, entertainment. If this invention is being utilized in the context of print advertisements, direct-mail advertisements, radio, television or internet campaigns, this first step is unnecessary, and should be omitted.

Second, dealers and retailers must be educated regarding anticipated lead generation and timeliness of follow-ups with prospective customers generated through the lead generation process. The dealer and retailer education comprises how leads are qualified, i.e., segregation, method of delivering leads to the dealer and retailer, the information provided as part of the lead generation, and practices for successful follow-up on leads to generate actual product or service sales, i.e., promptness of follow-up in relation to receipt of lead contact information. Education of retailers and dealers regarding the forthcoming leads is key and aids in the overall success rate of the marketing campaign. However, the user of this method may elect to omit this training from its implementation of this method bearing in mind that overall success of the campaign will also be compromised.

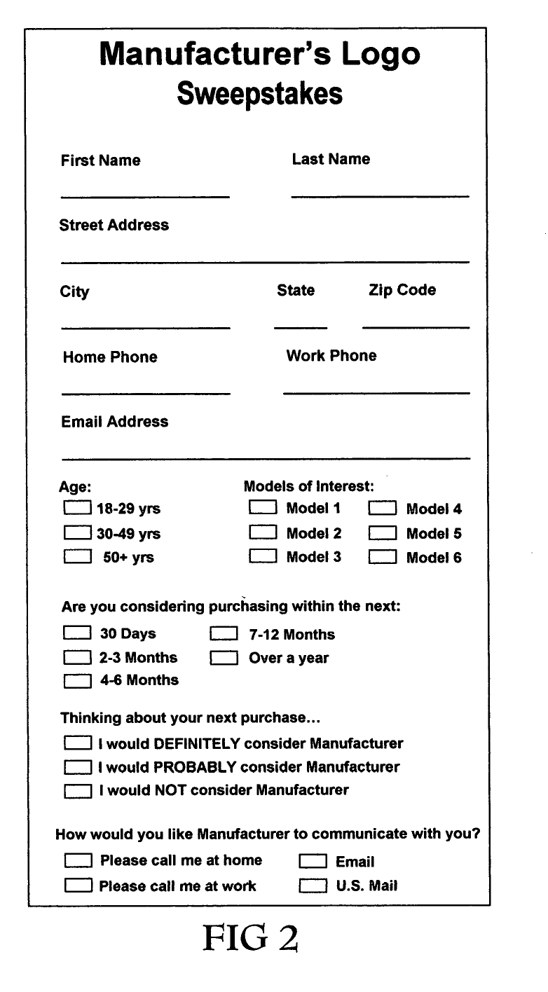

The third step, which is the first step when implementing this method with regard to direct mail, print, television, radio or internet advertising campaigns, is the actual lead generation and compilation leads through an incentive program. The incentive is intended to build enthusiasm and pique the interest of the prospective lead, i.e., purchaser. The incentive is generally a sweepstakes or lottery. The sweepstakes may be hourly drawings for a prize each hour, a single grand prize drawing, or a combination of both hourly drawings with a grand prize drawing at the end of the campaign. Regardless, the incentive must fit the audience. For example, at a car show, visitors are interested in cars, thus the user of this method, i.e., the auto manufacturer, would offer their car as the grand prize. The lead is generated by having the participant complete an entry form to enter the sweepstakes. A preferred embodiment of the entry form is depicted in FIG. 2. The entry form solicits, at a minimum, the lead's name, address, telephone numbers, and purchase horizon, i.e., the anticipated time frame to purchase. It is preferred that the entry form also request e-mail addresses, and include check-off boxes for: (1) how the prospect/lead wishes to be contacted in the future, i.e., at home, at work, by mail, e-mail, or no preference; prospect's age group; specific models or services the lead is interested in; purchase horizon, i.e., 1 to 30 days, 2-3 months, 4-6 months, 7-12 months, or over a year; and how the lead feels about the product, i.e., would definitely purchase the product, probably consider the product, would not consider the product at all.

The fourth step in this process is qualification of the leads accumulated from through incentive program. The leads are initially culled by hand into two categories, correctly completed entry forms, and rejected entries, e.g., incomplete or patently false entry forms. This hand cull is done as a precursor to eliminate bad leads from entering the computer data base. The information from the accepted entry forms are entered into a computer database which mirrors the subject-matter solicited on the entry forms. The computer program then segregates the leads into at least two categories: (a) Buy-Now™ Leads comprising 0 to 6 month purchase horizon, and (b) Buy-Later™ Leads comprising a purchase horizon of greater than 6 months. It is preferred that the leads are segregated into four categories: (a) Buy-Now™ Lead comprising 0-30 day purchase horizon; (b) Buy-Soon™ Lead comprising 2-3 month purchase horizon; (c) Buy-Later™ Lead comprising 4-12 month purchase horizon; and (d) Buy-Next Year™ Lead with a purchase horizon of greater than 12 months.

The fifth step is timely delivery of the culled qualified leads to the manufacturer's retailers and dealers. The leads are processed and distributed in accordance with their purchase horizon priority, i.e., Buy-Now™ Leads are distributed first and Buy-Next Year™ Leads distributed last. It is preferred that delivery is accomplished via an FTP internet site with the dealer/retailer being notified of lead availability. The use of an FTP site provides the advantage of allowing the manufacturer or advertiser to know if the dealer/retailer has “picked-up” their leads within the deadline set by the manufacturer or service provider. If the leads have not been retrieved by the retailer/dealer within the manufacturer's pre-determined time period, the leads may be made available to the next local retailer/dealer in the geographic area, and the original dealer/retailer recipient may be locked out from accessing the leads.

The determination of the effectiveness of this method is quite easy. The user can either perform a measured follow-up by contacting a sample of the leads, preferably 40 leads, from the qualified list provided to a dealer/retailer to determine if the dealer or retailer in fact solicited the lead. After thanking the lead for participating in incentive program, the advertiser or manufacturer will also inquire if the lead: (a) purchased the product or service; (b) whose product or service they did purchase; (c) whether they were contacted by the manufacturer's or advertiser's local dealer/retailer; and (d) if the lead has not yet made a purchase does the manufacturer/advertiser still under consideration for actual product or service purchase. Like Step 2, this step may also be omitted by the user with the understanding that it may have an adverse impact on the success of the campaign.

Alternatively, the rate of return on investment is the determined by comparing the qualified leads accumulated through the incentive program with the manufacturer's/advertisers purchaser lists compiled from warranty data, or retailer purchaser registries to establish the actual rate of return on the investment made in the promotional advertising campaign or trade show event.

The most accurate determination for rate of return is the implementation of both methods, i.e., sampling of qualified leads and comparison of lead lists with actual purchaser lists.

As noted above, the first two steps are omitted with regard to print, direct mail, television, radio or internet marketing campaigns. Although not preferred or encouraged, the first two steps may likewise be omitted from live events.

What is claimed is:

1. A method of collecting, identifying, and distributing customer leads resulting in increased rate of return on marketing investment comprising:
Collecting potential customer leads using an entry form which requires at least name, address and purchase horizon;
Segregation of customer leads into two categories of properly completed entry form customer leads and incomplete entry form customer leads;
Entry of properly completed entry form customer leads into computer data base which further segregates customer leads by geographic location and least two purchase horizon categories of Buy-Now and Buy Later;
Delivery of properly completed entry form customer leads to retailers in conformity with purchase horizon and geographic location.

2. The method as claimed in claim 1 of collecting potential customer leads on an entry form is accomplished through a sweepstakes drawing.

3. The method as claimed in claim 1 wherein the properly completed entry form customer leads are segregated into four categories of Buy-Now Lead, Buy-Soon Lead, Buy-Later Lead, and Buy-Next Year Lead.

4. The method as claimed in claim 1 wherein delivery of the properly completed is accomplished via an FTP internet web site.

5. The method as claimed in claim 1 wherein said entry form seeks the potential customer lead's name, address, telephone number, purchase horizon, e-mail address, preferred method of contact, age, and product of interest.

6. The method in as in claim 2 wherein said sweepstakes is hourly drawings with an ultimate grand prize drawing at the end of the sweepstakes.

7. A method of collecting, identifying, and distributing customer leads resulting in increased rate of return on marketing investment comprising:
Attracting potential customer leads with suitable product specialists to complete an entry form;
Collecting entry forms which requires at least name, address and purchase horizon from potential customer lead;
Segregation of customer leads into two categories of properly completed entry form customer leads and incomplete entry form customer leads;
Entry of properly completed entry form customer leads into computer data base which further segregates customer leads by geographic location and least two purchase horizon categories of Buy-Now and Buy Later;
Delivery of properly completed entry form customer leads to retailers in conformity with purchase horizon and geographic location.

8. The method as claimed in claim 7 of collecting potential customer leads on an entry form is accomplished through a sweepstakes drawing.

9. The method as claimed in claim 7 wherein the properly completed entry form customer leads are segregated into four categories of Buy-Now Lead, Buy-Soon Lead, Buy-Later Lead, and Buy-Next Year Lead.

10. The method as claimed in claim 7 wherein delivery of the properly completed is accomplished via an FTP internet web site.

11. The method as claimed in claim 7 wherein said entry form seeks the potential customer lead's name, address, telephone number, purchase horizon, e-mail address, preferred method of contact, age, and product of interest.

12. The method in claim 8 wherein said sweepstakes is hourly drawings with an ultimate grand prize drawing at the end of the sweepstakes.

13. The method in claim 7 wherein the suitable product specialists comprise persons with superior interpersonal skills, articulate, friendly, outgoing, knowledgeable about product.

14. A method of collecting, identifying, and distributing customer leads resulting in increased rate of return on marketing investment comprising:
Attracting potential customer leads with suitable product specialists to complete an entry form;
Collecting potential customer leads using an entry form which requires at least name, address and purchase horizon;
Segregation of customer leads into two categories of properly completed entry form customer leads and incomplete entry form customer leads;
Entry of properly completed entry form customer leads into computer data base which further segregates customer leads by geographic location and least two purchase horizon categories of Buy-Now and Buy Later;
Educating retailers on the necessity of timely solicitation of leads generated;
Delivery of properly completed entry form customer leads to retailers in conformity with purchase horizon and geographic location.

15. The method as claimed in claim 14 of collecting potential customer leads on an entry form is accomplished through a sweepstakes drawing.

16. The method as claimed in claim 14 wherein the properly completed entry form customer leads are segregated into four categories of Buy-Now Lead, Buy-Soon Lead, Buy-Later Lead, and Buy-Next Year Lead.

17. The method as claimed in claim 14 wherein delivery of the properly completed is accomplished via an FTP internet web site.

18. The method as claimed in claim 14 wherein said entry form seeks the potential customer lead's name, address, telephone number, purchase horizon, e-mail address, preferred method of contact, age, and product of interest.

19. The method in claim 14 wherein the suitable product specialists comprise persons with superior interpersonal skills, articulate, friendly, outgoing, knowledgeable about product.

20. The method in as in claim 15 wherein said sweepstakes is hourly drawings with an ultimate grand prize drawing at the end of the sweepstakes.
